(19) United States
(12) Patent Application Publication
(10) Pub. No.: US 2003/0215209 A1
(43) Pub. Date: Nov. 20, 2003

(54) Data transmission apparatus, data receiving apparatus, recording medium, data transmitting method, and data receiving method

(75) Inventor: Tomoyuki Kawaguchi, Koufu-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/419,259

(22) Filed: Apr. 21, 2003

(30) Foreign Application Priority Data
May 15, 2002 (JP) P2002-140698

(51) Int. Cl. H04N 9/79

(52) U.S. Cl. 386/7

(57) ABSTRACT

One of the objects of the present invention is to provide an apparatus that can transmit information concerning special playback intended by the author of a content by using program streams or transport streams and properly convert or transmit the special playback information during format conversion or transmission.

A data transmission apparatus is provided with a data compression device for compressing input content data into a data format consisting of a plurality of groups together with playback control information for controlling the playback of the content data, the groups being related to each other, each of the groups being a collection of a plurality of data components making up the content data; a generation device for generating special playback control information for controlling special playback intended by a content author of the content data; a data inclusion device for including the generated special playback control information into the compressed content data; and a transmission device for transmitting the compressed data including the special playback control information.

### BACKGROUND OF THE INVENTION

1. Field of the Invention

The present invention relates to a digital image data transmission apparatus, a digital image data receiving apparatus, and a recording medium for recording digital image data and, in particular, to special playback, such as thumbnail playback, of digital image data.

2. Description of the Related Art

The recording capacity of optical discs has considerably increased in recent years, and along with this increase, optical discs on which a compressed movie is recorded (so-called the DVD (Digital Versatile Disc)) is becoming commonplace.

DVD standards for recording data on DVDs widely used include MPEG (Moving Picture Expert Group)-2, which is a standard for moving picture compression, and AC (Audio Compression)-3 and MPEG Audio, which are standards for audio compression. Compressed data is packed/packetized before recording or transmitting along with run-length-compressed sub-image data such as closed caption to be displayed during playback of movie images and control information called navi-pack for controlling fast-forward playback and playback mode of images.

In recent years, digital broadcasting systems known as BS (Broadcasting Satellite) digital broadcasting and CS (Communication Satellite) digital broadcasting have come into service, in which television programs are sent as digital television signals through a satellite such as a broadcast satellite or a communication satellite and received and watched at homes.

In such a broadcasting system, MPEG-2 is used to compress image data and transmitted. Especially, transport stream transmission is used in digital broadcasting, in which transmission time is broken into relatively short transmission units and multiplexed to transmit a number of programs.

However, such program streams or transport streams have raised the following difficulty: They are not standardized in such a way that data for controlling special playback intended by the author of a video content is recorded in user information areas or private user areas.

Therefore, information for controlling special playback intended by the video content author, such as partial playback and thumbnail playback, cannot be properly transmitted and, as a result, the special playback intended by the author cannot be accomplished.

Furthermore, according to MPEG-2, information for controlling playback of content data is typically stored in control information areas such as navi-pack areas. Therefore, it sometimes occurs that the control information stored in these control areas cannot properly converted or transmitted during conversion or transmission of the format of the video content and, as a result, the special playback cannot be effected in the converted or transmitted content data.

### SUMMARY OF THE INVENTION

The present invention has been made to solve these inconvenience. An object of the present invention is to provide a data transmission apparatus and a data receiving apparatus that can transmit information concerning special playback intended by the author of a content by using program streams or transport streams and properly convert or transmit the special playback information during format conversion or transmission, and a recording medium for recording the special playback information.

The above object of the present invention can be achieved by a data transmission apparatus of the present invention. The data transmission apparatus is provided with: a data compression device for compressing input content data into a data format consisting of a plurality of groups together with playback control information for controlling the playback of the content data, the groups being related to each other, each of the groups being a collection of a plurality of data components making up the content data; a generation device for generating special playback control information for controlling special playback intended by a content author of the content data; a data inclusion device for including the generated special playback control information into the compressed content data; and a transmission device for transmitting the compressed data including the special playback control information.

According to the present invention, information about special playback intended by the author of content data is included in the content data compressed into a format consisting of a plurality of groups together with playback control information and then the content data including the special playback control information is sent.

Thus, the receiver of the content data can perform various types of special playback such as playback with thumbnails, partial playback, and fast-forward playback by decompressing the compressed content data and controlling the special playback of the content data according to the special playback control information. The intension of the author of the content can be reflected in the special playback.

Furthermore, the special playback control information can be transferred along with the content data by the receiver without being lost when the compressed content data is transferred because the special playback information is included in the compressed content data itself.

Furthermore, content data compressed into a data format consisting of a plurality of groups of plurality of data components comprises areas containing the compressed content data and areas containing playback control information. Therefore, when the receiver of the content data transfers it, playback control information may not properly be transmitted, depending on the arrangement of the receiver.

Furthermore, by contrast, the special playback control information is included in the content data itself so that the special playback control information can be properly transmitted even if playback control information is not properly transmitted.

In one aspect of the present invention can be achieved by the data transmission apparatus of the present invention. The data transmission apparatus is, wherein: the data inclusion device includes into the compressed content data identification data indicating that the playback control information is contained in the content data when including the playback control information into the compressed content data.

According to the present invention, the identification data is also included into the compressed content data when playback control information is included into it for indicating that the content data contains the playback control data.

Thus, the receiver of the content data can readily determine whether the compressed data contains special playback control information by decompressing the compressed data and reading the identification data.

In another aspect of the present invention can be achieved by the data transmission apparatus of the present invention. The data transmission apparatus is, wherein: the special playback control information generated by the generation device includes at least either recording position information indicating the positions in which the data components used in the special playback are recorded or control information for controlling the order in which the data components are played back during the special playback or the length of time for which the special playback of each of the data components is performed.

According to the present invention, the special playback control information generated contains at least either recording position information indicating the positions in which the data components used for special playback are recorded or control information for controlling the order in which the data components are played back during special playback or the length of time for which special playback of each data component is performed. Thus, the receiver of the content data can control the order in which the data components are played back or the length of time for which they are played and can perform the special playback intended by the author of the content.

In further aspect of the present invention can be achieved by the data transmission apparatus of the present invention. The data transmission apparatus is, wherein: the generation device generates one or more pieces of special playback control information for controlling special playback of the data components of each of the groups in the content data and adds position information to each piece of the special playback control information for indicating the positions in which the other pieces of special playback control information are placed; the inclusion device includes the one or more pieces of special playback control information generated into the each group.

According to the present invention, special playback control information for controlling special playback of data components of each group is generated and the position information indicating the positions in which other pieces of special playback control information are placed is added to each special playback control information. In addition, one or more pieces of special playback control information generated are included in each group.

Thus, the receiver of the content data can referring to the position information contained in special playback control information to control special playback to distribute the special playback control information throughout the content data while decompressing the compressed content data. As a result, problem which would otherwise be caused by special playback control information localized in such a manner that a group contains only one piece of special playback control information or only one of a plurality of groups contains a piece of special playback control information can avoided. That is, problems can be avoided such as increased complexity of transmission along the real time axis, or a delay in accessing each data component in a large amount of special playback control information.

In further aspect of the present invention can be achieved by the data transmission apparatus of the present invention. The data receiving apparatus for receiving and playing back content data transmitted from the data transmission apparatus of the present invention, the receiving apparatus is provided with: a receiving device for receiving the content data including special playback control information for controlling special playback intended by a content author, the content data being compressed into a data format consisting of a plurality of groups together with the playback control information for controlling the playback of the content data; a obtaining device for obtaining the special playback control information included in the compressed content data; and a playback device for decrypting the received compressed content data on the basis of the obtained special playback control information and performing the special playback of the content data.

According to the present invention, the receiver of content data receives the content data that includes control information about special playback intended by the author the content and is compressed into a format consisting of a plurality of groups, decompresses the content data compressed on the basis of the contained special playback control information, and perform the special playback of the content data.

Thus, the playback of the content can be controlled on the basis of the special playback control information sent together with the content data, therefore various types of special playback can be achieved such as playback with a thumbnail, partial playback, and fast-forward playback. In addition, the intention of the content author can be reflected in the special playback.

Furthermore, the special playback control information can be transferred along with the content data by the receiver without being lost when the compressed content data is transferred because the special playback information is included in the compressed content data itself.

Furthermore, content data compressed into a data format consisting of a plurality of groups of plurality of data components comprises areas containing the compressed content data and areas containing playback control information. Therefore, when the receiver of the content data transfers it, playback control information may not properly be transmitted, depending on the arrangement of the receiver.

Furthermore, special playback control information is included in content data itself so that the special playback control information can be properly transmitted even if playback control information is not properly transmitted.

In further aspect of the present invention can be achieved by the data transmission apparatus of the present invention. The data receiving apparatus of the present invention is, wherein: the content data contains identification information indicating that the content data contains the special playback control information and the obtaining device obtains the identification information when obtaining the special playback control information.

According to the present invention, the identification information obtained when the special playback control information can be used to readily determine whether the content data contains special playback control information.

In further aspect of the present invention can be achieved by the data transmission apparatus of the present invention. The data receiving apparatus of the present invention is, wherein: the special playback control information includes at least either recording position information indicating the positions in which the data components used in the special playback are recorded or control information for controlling the order in which the data components are played back during the special playback or the length of time for which the special playback of each of the data components is performed; the obtaining device obtains the control information when obtaining the special playback control information; and the playback control device performs the special playback on the basis of the obtained control information.

According to the present invention, at least either the recording position information indicating the position in which the data components used for special playback is recorded or control information for controlling the order in which the data components are played back during special playback or the length of time for which special playback of each data component is performed is obtained and the special playback is performed on the basis of the control information. Therefore, special playback intended by the content author can be properly performed even if various types of special playback such as playback with thumbnails, partial playback, and fast-forward playback are performed.

In further aspect of the present invention can be achieved by the data transmission apparatus of the present invention. The data receiving apparatus is, wherein: each of the groups includes one or more pieces of the special playback control information for controlling the special playback of the data components of each of the groups in the content data and position information indicating the positions in which the other pieces of special playback control information is added to each piece of the special playback control information; and the playback device refers to each piece of the special playback control information included in each of the groups on the basis of each piece of the position information to perform the special playback.

According to the present invention, each piece of special playback control information is included in each group is referred to on the basis of each piece of position information to accomplish special playback.

Therefore, the problem which would otherwise be caused by special playback control information localized in such a manner that a group contains only one piece of special playback control information or only one of a plurality of groups contains a piece of special playback control information can be avoided. That is, problems can be avoided such as a delay in accessing each data component in a large amount of special playback control information.

The above object of the present invention can be achieved by a recording medium of the present invention. The recording medium is provided with a recording area for recording content data compressed together with playback control information for controlling the content data into a data format consisting of a plurality of groups, each of the groups being a collection of a plurality of related data components making up the content data, wherein the recording area stores the compressed data including special playback control information for controlling special playback intended by the author of said content data.

According to the present invention, special playback of content data is performed on the basis of special playback control information for controlling special playback intended by the author of the content during special playback of the content data. Thus, various types of special playback intended by the content author, such as playback with thumbnails, partial playback, and fast-forward playback, can be ensured.

In one aspect of the present invention can be achieved by the recording medium of the present invention. The recording medium of the present invention is, wherein: the recording area stores the content data including identification data indicating that the special playback control information is contained in the content data.

According to the present invention, it can be readily determined whether or not content data contains special playback control information on the basis of obtained identification data indicating that the content data contains playback control information.

In another aspect of the present invention can be achieved by the recording medium of the present invention. The recording medium of the present invention is, wherein the recording area stores the content data including special playback control information including control information for controlling at least either the order in which the data contents are played back during special playback or the length of time for which each of the data components is played back.

According to the present invention, the order in which data components are played back or playback time of the data components can be properly controlled and therefore special playback intended by the author of the content can be ensured by obtaining the control information that controls at least either the order in which the data components are played back or the special playback time of each data component which is included in the special playback control information generated during special playback of content data.

In further aspect of the present invention can be achieved by the recording medium of the present invention. The recording medium of the present invention is, wherein: each of the groups includes one or more pieces of the special playback control information for controlling special playback of the data components of each of the groups in the content data; and the recording area stores the content data including the special playback control information, each piece of the special playback control information having position information indicating the positions in which the other pieces of special playback control information are placed.

According to the present invention, the compressed content data is decompressed and, when special playback is to be performed, the special playback is controlled with reference to position information included in special playback control information dispersed throughout the content data. Thus, the problem can be prevented which would otherwise be caused by special playback control information localized in such a manner that only one group contains a piece of special playback control information or only one of a plurality of groups contains special playback control information. That is, a delay in accessing each data components in a large amount of special playback control information can be avoided.

The above object of the present invention can be achieved by a data transmission method of the present invention. The data transmission method is provided with: a data compression process of compressing input content data into a data format consisting of a plurality of groups together with playback control information controlling playback of the content data, each of the groups being a collection of plurality of data components making up the content data; a generation process of generating special playback control information for controlling playback intended by the author of the content data; a data inclusion process of including the generated special playback control information into the compressed content data; and a transmission process of transmitting the compressed content data including the special playback control information.

According to the present invention, information about special playback intended by the author of content data is included in the content data compressed into a format consisting of a plurality of groups together with playback control information and then the content data including the special playback control information is sent.

Thus, the receiver of the content data can perform various types of special playback such as playback with thumbnails, partial playback, and fast-forward playback by decompressing the compressed content data and controlling the special playback of the content data according to the special playback control information. The intension of the author of the content can be reflected in the special playback.

Furthermore, the special playback control information can be transferred along with the content data by the receiver without being lost when the compressed content data is transferred because the special playback information is included in the compressed content data itself.

Furthermore, content data compressed into a data format consisting of a plurality of groups of plurality of data components comprises areas containing the compressed content data and areas containing playback control information. Therefore, when the receiver of the content data transfers it, playback control information may not properly be transmitted, depending on the arrangement of the receiver.

Furthermore, by contrast, the special playback control information is included in the content data itself so that the special playback control information can be properly transmitted even if playback control information is not properly transmitted.

In one aspect of the present invention can be achieved by the data transmission method of the present invention. The data transmission method of the present invention is, wherein: the data inclusion process includes identification information into the content data for indicating that the content data contains the playback control information when the playback control information is included in the compressed content data.

According to the present invention, the identification data is also included into the compressed content data when playback control information is included into it for indicating that the content data contains the playback control data.

Thus, the receiver of the content data can readily determine whether the compressed data contains special playback control information by decompressing the compressed data and reading the identification data.

In another aspect of the present invention can be achieved by the data transmission method of the present invention. The data transmission method of the present invention is, wherein: the special playback control information includes at least either recording position information indicating the positions in which the data components used in the special playback are recorded or control information for controlling the order in which the data components are played back during the special playback or the length of time for which the special playback of each of the data components is performed.

According to the present invention, the special playback control information generated contains at least either recording position information indicating the positions in which the data components used for special playback are recorded or control information for controlling the order in which the data components are played back during special playback or the length of time for which special playback of each data component is performed. Thus, the receiver of the content data can control the order in which the data components are played back or the length of time for which they are played and can perform the special playback intended by the author of the content.

In further aspect of the present invention can be achieved by the data transmission method of the present invention. The data transmission method of the present invention is, wherein: the generation process generates one or more pieces of special playback control information for controlling special playback of the data components of each of the groups in the content data and adds position information to each piece of the special playback control information for indicating the positions in which the other pieces of special playback control information are placed.

According to the present invention, special playback control information for controlling special playback of data components of each group is generated and the position information indicating the positions in which other pieces of special playback control information are placed is added to each special playback control information. In addition, one or more pieces of special playback control information generated are included in each group.

Thus, the receiver of the content data can referring to the position information contained in special playback control information to control special playback to distribute the special playback control information throughout the content data while decompressing the compressed content data. As a result, problem which would otherwise be caused by special playback control information localized in such a manner that a group contains only one piece of special playback control information or only one of a plurality of groups contains a piece of special playback control information can avoided. That is, problems can be avoided such as increased complexity of transmission along the real time axis, or a delay in accessing each data component in a large amount of special playback control information.

In further aspect of the present invention can be achieved by the data transmission method of the present invention. The data receiving method for receiving and playing back content data transmitted by the transmission method of the present invention, the data receiving method is provided with: a receiving process of receiving the content data compressed in a format consisting of a plurality of groups together with the playback control information for controlling the content data, the content data including special playback control information for controlling special playback intended by a content author; an obtaining process of obtaining the special playback control information included in the compressed content data; and a playback process of decrypting the received compressed data and performing the special playback of the content data on the basis of the obtained special playback control information.

According to the present invention, content data is received which is compressed into a format consisting of a plurality of groups along with playback control information and contains information about special playback intended by the author of the content. The compressed data received is decompressed on the basis of the special playback control information and the special playback of the content data is performed.

The receiver of content data receives the content data that includes control information about special playback intended by the author the content and is compressed into a format consisting of a plurality of groups, decompresses the content data compressed on the basis of the contained special playback control information, and perform the special playback of the content data.

Thus, the playback of the content can be controlled on the basis of the special playback control information sent together with the content data, therefore various types of special playback can be achieved such as playback with a thumbnail, partial playback, and fast-forward playback. In addition, the intention of the content author can be reflected in the special playback.

Furthermore, the special playback control information can be transferred along with the content data by the receiver without being lost when the compressed content data is transferred because the special playback information is included in the compressed content data itself.

Furthermore, content data compressed into a data format consisting of a plurality of groups of plurality of data components comprises areas containing the compressed content data and areas containing playback control information. Therefore, when the receiver of the content data transfers it, playback control information may not properly be transmitted, depending on the arrangement of the receiver.

Furthermore, according to the present invention, special playback control information is included in content data itself so that the special playback control information can be properly transmitted even if playback control information is not properly transmitted.

In further aspect of the present invention can be achieved by the data receiving method of the present invention. The data receiving method of the present invention is, wherein: the content data includes identification data indicating that the playback control information is contained in the content data; and the obtaining process obtains the identification data when obtaining the special playback control information.

According to the present invention, the identification information obtained when the special playback control information can be used to readily determine whether the content data contains special playback control information.

In further aspect of the present invention can be achieved by the data receiving method of the present invention. The data receiving method of the present invention is, wherein: the special playback control information includes at least either recording position information indicating the positions in which the data components used in the special playback are recorded or control information for controlling the order in which the data components are played back during the special playback or the length of time for which the special playback of each of the data components is performed; the obtaining process obtains the control information when obtaining the special playback control information; and the playback control process performs the special playback on the basis of the obtained control information.

According to the present invention, at least either the recording position information indicating the position in which the data components used for special playback is recorded or control information for controlling the order in which the data components are played back during special playback or the length of time for which special playback of each data component is performed is obtained and the special playback is performed on the basis of the control information. Therefore, special playback intended by the content author can be properly performed even if various types of special playback such as playback with thumbnails, partial playback, and fast-forward playback are performed.

In further aspect of the present invention can be achieved by the data transmission apparatus of the present invention. The data receiving method of the present invention is, wherein: each of the groups includes one or more pieces of the special playback control information for controlling the special playback of the data components of each of the groups in the content data, and position information indicating the positions in which the other pieces of special playback control information is added to each piece of the special playback control information; and the playback process refers to each piece of the special playback control information included in each of the groups on the basis of each piece of the position information to perform the special playback.

According to the present invention, each piece of special playback control information is included in each group is referred to on the basis of each piece of position information to accomplish special playback.

Therefore, the problem which would otherwise be caused by special playback control information localized in such a manner that a group contains only one piece of special playback control information or only one of a plurality of groups contains a piece of special playback control information can be avoided. That is, problems can be avoided such as a delay in accessing each data component in a large amount of special playback control information.

### BRIEF DESCRIPTION OF THE DRAWINGS

FIG. 1 shows a physical format of the DVD video standard for recording content data on a recording medium;

FIG. 2 shows a configuration of a GOP conforming to the DVD standard for recording content data on a recording medium;

FIG. 3 shows a data structure of an MPEG video stream and the relationship between the data structure and a GOP;

FIG. 4 shows data organization of user information conforming to the DVD video standard for recording the content data according to a first embodiment of the present embodiment (playback with thumbnails);

FIG. 5 shows data organization of user information conforming to the DVD video standard for recording the content data according to the first embodiment of the present embodiment (partial playback);

FIG. 6 data organization of user information conforming to the DVD video standard for recording the content data according to the first embodiment of the present invention (playback with thumbnails to which link information is added);

FIG. 7 shows a physical format of the MPEG video standard for recording the content data;

FIG. 8 shows a configuration of an information recorder and player for recording and playing content data on recording a recording medium according to the first embodiment of the present invention;

FIG. 9 shows an exemplary relationship between a program stream and user information for performing special playback of the recording medium according to the first embodiment of the present invention;

FIG. 10 shows a data structure of a transport stream and the relationship between the data structure and a GOP according to the second embodiment of the present invention;

FIG. 11 is a block diagram of a data transmission apparatus capable of performing special playback according to the second embodiment of the present invention;

FIG. 12 is a flowchart of a transmission operation performed by the data transmission apparatus for transmitting content data to a data receiving apparatus according to the second embodiment of the present invention;

FIG. 13 is a block diagram of a data transmission apparatus capable of performing special playback according to the third embodiment of the present invention;

FIG. 14 shows the relationship between a transport stream and user information during special playback based on special control information on a recording medium according to the third embodiment of the present invention; and

FIG. 15 is a flowchart of an operation (special playback operation) performed by a data receiving apparatus for receiving content data according to the third embodiment of the present invention.

### DETAILED DESCRIPTION OF THE PREFERRED EMBODIMENTS

Preferred embodiment of the present invention will be described below with reference to the accompanying drawings.

(First Embodiment)

In a first embodiment, the present invention is applied to recording medium such as DVD-R/RW on which program streams of images and other data are recorded and a recorder/player for recording and playing back program streams on the recording medium.

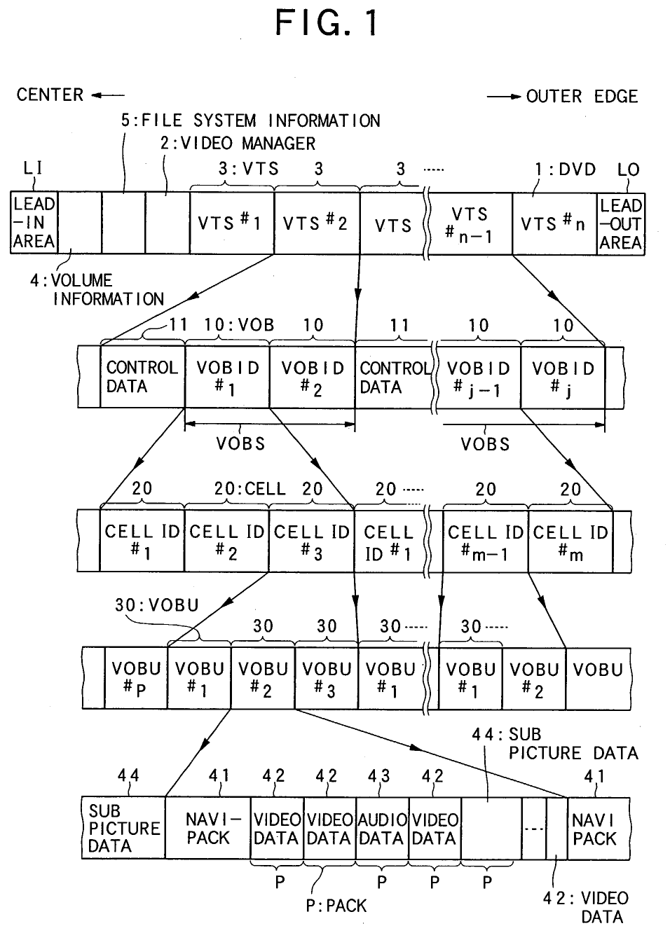

Referring to FIGS. 1 to 7, the DVD standard for the DVD video format, which is the recording format used in the first embodiment, will be outlined first.

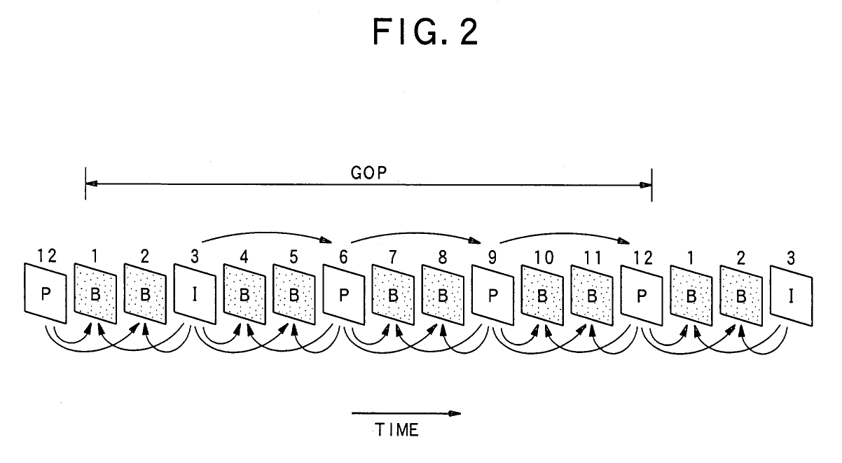

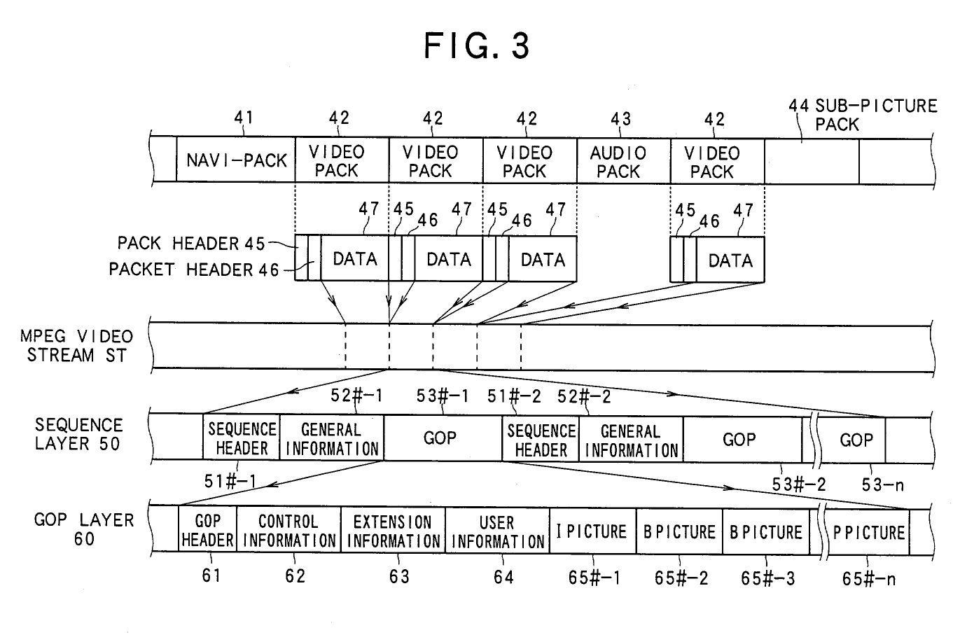

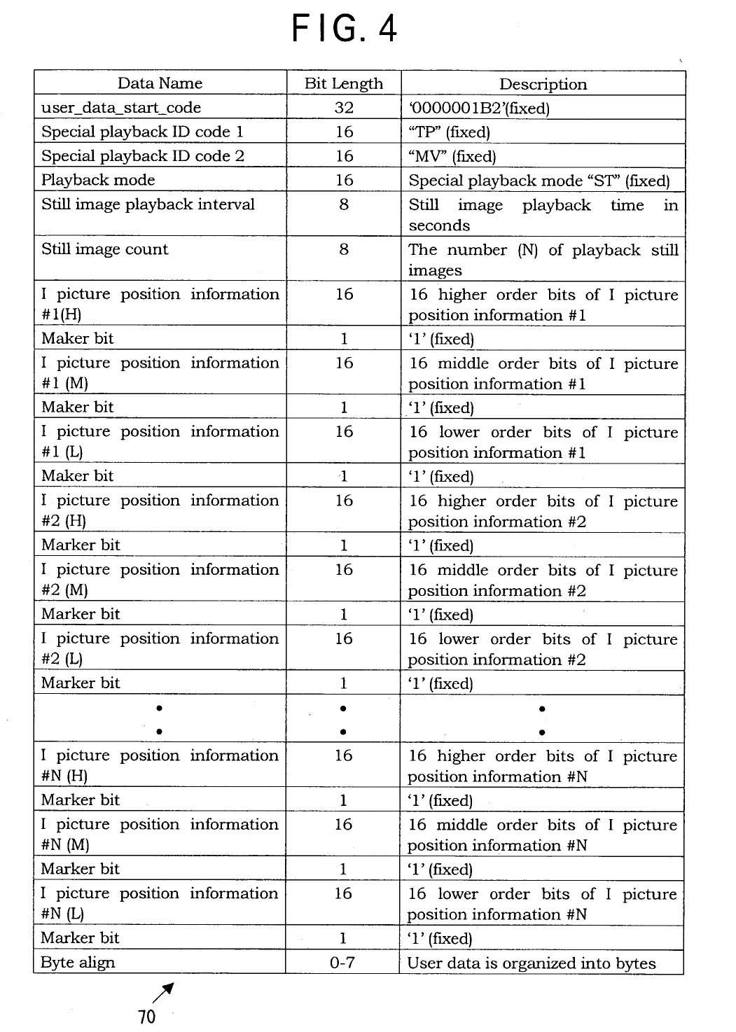

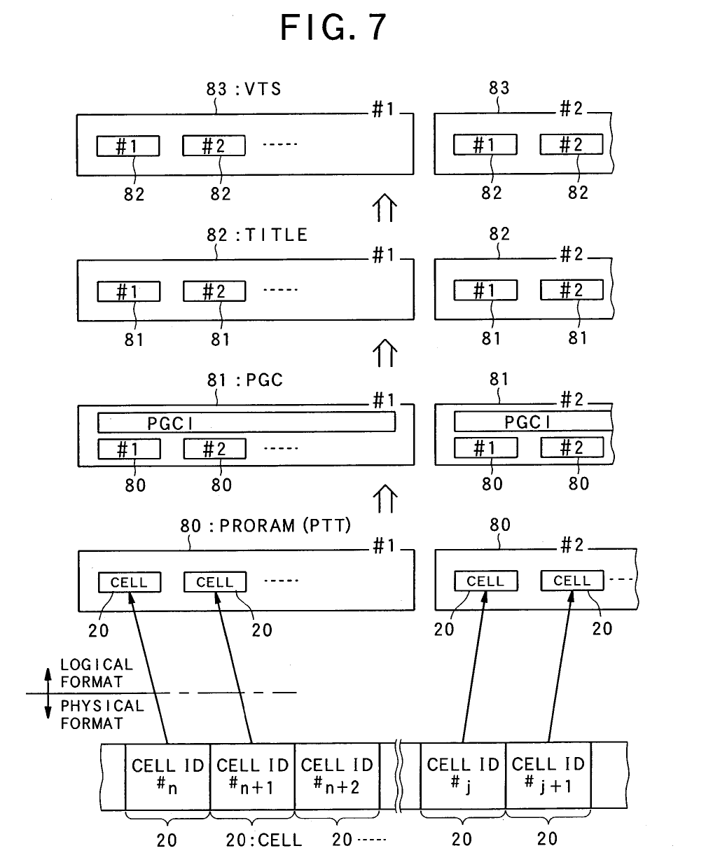

FIG. 1 shows a physical recording format for the DVD video format. FIG. 2 shows a configuration of a GOP (Group Of Picture) according to the DVD video specifications. FIG. 3 shows a logical format according to the video format. FIGS. 4 to 6 show exemplary data configurations of user information. FIG. 7 shows a logical format according to MPEG video specifications for recording content data.

The DVD used in the present embodiment is in particular a recordable DVD such as a DVD-R (DVD-Recordable), which can be rewritten only once or a DVD-RW (DVD-Rerecordable), which can be written more than one time.

A DVD 1 on which information is recorded according to the DVD video specifications has a lead-in area LI in its innermost region and a lead-out area LO in its outermost region as shown in FIG. 1. Recorded between them are video information and audio information divided into a plurality of VTSs (Video Title Sets) 3 (VTS#1 to VTS#n) having an ID (identification) number.

A video manager 2 is recorded in the area immediately preceding the area (a recording area of the present invention) in which the VTSs 3 are recorded. Recorded in a region between the video manager 2 area and the lead-in area L1 are volume information 4 for identifying the entire information recorded on the DVD 1 and file system information 5 indicating the file structure of data in the video manager 2 and each VTS 3.

The video manager 2 has VMGI (Video Manager Information).

The VMGI includes information relating to the entire audio and video information recorded on the DVD 1, such as a menu listing titles, information for illegal-copy protection, an access table for accessing each title, and backups of these items of information.

A VTS 3 represents a content, such as a movie, presented by its author to viewers and is a set (collection) of related titles. The VTSs 3 include as separate titles a plurality of versions in different languages of one movie or a theatrical version and a special version of one movie.

For example, the related titles may include data having the same attributes, such as the same audio information, the number of sub-pictures such as captions, specifications, and language.

Each VTS3 consists of control data 11 positioned at the beginning, a plurality of objects 10, which is content data according to the present invention, to which an ID number is assigned (video objects (VOBs) in the present embodiment because it deals with video information).

In the DVD standard, the part consisting of the plurality of VOBs 10 is referred to as a VOB set (VOBS). The term VOB set is used for distinguishing the part consisting of the plurality of VOBs 10, which are the substance of video and audio information, from the control data 11, which is the other data in the VTS 3.

The control data 11 contains PGCI (Program Chain Information), which is various items of information about a program chain, which is the logical unit of a combination of a plurality of cells, which will be described later, and VTSI (Video Title Set Information), which is the backup of those items of information.

Each VOB 10 contains, besides the control information, video information, video images, and the substance of video information, that is, sound. The content data is divided into the plurality of VOBs 10 and recorded.

Furthermore, each VOB 10 ends with a plurality of cells 20, each having an ID number. Each of the cells 20 consists of a plurality of VOB units (VOBUs) 30, each having an ID number, and does not extend across two VOBs 10.

Each VOB unit 30 has unit information including video information, audio information, and sub-picture information and consists of packs 41 indicating navigation information containing control information controlling data in that VOB unit 30 (hereinafter simply referred to as a navi-pack), video data 42 containing video information only, audio data 43 containing audio information only, and sub-picture data 44 containing only graphic information such as characters and graphics, as sub-picture information.

Each VOB unit 30 always starts with a navi-pack 41, followed by video data 42, audio data 43, and then sub-picture data 44.

Furthermore, the amount of data recorded in each VOB unit 30 is such that the length of playback time of the data between one navi-pack 41 and the next navi-pack becomes within the range from 0.4 to 1 second. Accordingly, a navi-pack 41 is detected every 0.4 to 1 second during playback.

Each of sections, video data 42, audio data 43, and sub-picture data 44, is generally called a pack. The video data 42, audio data 43, and sub-picture data 44 are divided and recorded in packs in each VOB unit 30.

The video data 42, audio data 43, and sub-picture data 44 will be described below.

In the DVD standard, a pack containing video data 42 is referred to as a video pack, a pack containing audio data 43 is referred to as an audio pack, and a pack containing sub-picture data 44 is referred to as a sub-picture pack.

It is not necessarily required that a VOB unit 30 should contain video data 42, audio data 43, and sub-picture data 44. Also, the number of pieces of video, audio, sub-picture data in a VOD unit 30 and the order in which they appear can be set arbitrarily.

The DVD standard specifies that one DVD 1 can contain 8 audio streams and 32 sub-picture streams.

The pack header at each pack contains time information called SCR (System Clock Reference). The SCR indicates read start time along the playback time axis at which data contained in each pack should be read from a track buffer in an information player reproducing information recorded on a DVD 1 and supplied into a buffer.

Each pack is typically subdivided into recording units called packets and video data 42, audio data 43, or sub-picture data 44 is recorded in each packet. Each packet comprises a pack header and a system header, each of which are a combination of a number of PES (Packetized Elementary Stream) packets (hereinafter referred to as PES packets).

A packet represents a basic unit of a program stream (element data such as video data (video pack) or audio data (audio pack)).

A navi-pack 41 has DSI data, which is search information for finding video or audio data to be played back and PCI data, which is information about playback control for presenting the video or audio data found on the basis of the DSI data. For example, the search information includes the address on the DVD 1 at which the video or audio data to be played back is recorded.

The PCI data contains highlight information defining a display or action provided when an option is selected by a viewer. The highlight information is used to make settings of the screen display.

Settings included in the highlight information are for example a change in the display image of a selected option in a menu that lists options to be selected by a PCI viewers, display positions to be changed in response to the selection, a command corresponding to the selected option, in particular, an instruction indicating an action to be performed for the selected option.

According to the DVD standard, image information for displaying images such as boxes and selection buttons required for constructing and displaying menus is recorded as sub-picture data 44, which is sub-picture information described above.

Every video pack 42 consists of one or more GOPs (Group Of Picture).

A GOP is specified in the MPEG 2 standard, which is the image compression method used in the present embodiment for recording video information on the DVD 1 and is the minimum unit of image that can be played back by itself. Recorded at the beginning of each GOP is playback time information called a PTS (Presentation Time Stamp) that indicates playback time along the playback time axis at which the video data 42 contained in that GOP.

Details of MPEG 2 and GOP having the characteristics described above will be described later.

An audio pack 43 contains audio information associated with video information recorded in the video pack 42. The audio information recorded in the audio pack 43 may be recorded according to MPEG 2 Audio or AC-3, for example.

A sub-picture pack 44 contains only graphic data such as characters and graphics as sub-picture data 44.

In this way, content data is recorded on the DVD 1 of the present embodiment in the physical recording format of the video system described above.

MPEG-2 used in the present embodiment for compressing content data will be outlined below.

In MPEG-2, each frame in a sequence of frame images is recorded along with information about the difference between frame images and motion vector. When each frame image is played back, this information is referred to and another frame is predicted from the plurality of frame images and played back. Data is compressed by taking account the fact that the frame images preceding and following a frame image are likely to be similar to each other and have interrelationship.

In particular, data is compressed in MPEG-2 by performing interpolation on the basis of motion vector of original images and generating, on the basis of a plurality of frame images transmitted with a number of frames between them, another frame image that exists between the plurality of frame images.

For example, if each GOP consists of 12 frame images as shown in FIG. 2, relationship between the image frames is as described below.

In FIG. 2, prediction (interpolation) relationships between pictures are indicated by arrows.

While the GOP consisting of 12 frame images is shown in FIG. 2 for convenience of explanation, the number of frame images in each GOP is not limited to this. In MPEG-2, the number typically depends on the amount of data in each image in MPEG-2.

A frame image indicated by the symbol “I” in FIG. 2 is called an I picture (intra-coded picture). A complete frame image can be played back using image information only from itself.

A frame image indicated by the symbol “P” is called a P picture (Predictive-coded picture) and generated by decrypting the difference between itself and a predicted image compensated and played back according to decrypted I pictures or other P pictures.

A frame image indicated by the symbol “B” is called B picture (Bidirectionally predictive-coded picture) and played back by using decrypted I pictures or P pictures as well as future I pictures or P pictures.

P pictures and the B pictures are derived from other frame images as predicted images. MPEG-2 uses them to compress image data.

MPEG-2 in this video system, a variable rate method is used in which the amount of data contained in individual GOPs is not constant.

In particular, in the MPEG-2, when the pictures contained in one GOP correspond to fast moving images and the correlation between pictures is lower, the amount of data for constructing each picture is larger and therefore the amount of data contained in one GOP is larger. On the other hand, when the pictures in each GOP correspond to a slow moving images and the correlation between pictures is large, the amount of data for constructing each picture is smaller and therefore the amount of data contained each GOP is smaller.

In MPEG-2 using the compression technology as describe above, read data in each video pack 42 is used to construct an MPEG video stream ST as shown in FIG. 3.

The video packs and MPEG video stream will be described below.

The MPEG video stream basically comprises six layers: a sequence layer, GOP layer, picture layer, slice layer, macro-block layer, and block layer. For convenience of explanation, however, only the data structures of the upper two layers, the sequence layer 50 and the GOP layer 60, will be used here.

Each of the video packs 42 making up a VOB unit 30 consists of a pack header 45, a packet header 46, and real data 47 (hereinafter simply referred to as data) having substantive video data, as shown in FIG. 3.

The MPEG video stream ST comprises data 47 and has the data structures of the sequence layer 50 and the GOP layer 60 as shown in FIG. 3.

The sequence layer 50 includes sequence headers 51 and general information 52 such as the number of pixels and aspect ratio of the image data as well as one or more GOPs 60.

The GOP layer 60 includes GOP headers 61 having a GSC (Group Start Code) indicating the start code of GOPs 60, control information 62 such as TC (Time Code) indicating the amount of time from the beginning of a sequence and specific information about playback and editing of the image data in the GOP, extension data 63 indicating playback control for the image data, user information 64 in which the author and user of the content can record information, and frame image data (picture layer) 65.

The control information 62 includes, besides the TC, data such as data indicating whether image data in the GOP can be played back independently of the other GOPs and whether the GOP can be used during editing.

The extension information 63 includes extension information such as copyright information (copy protection information such as data copy prohibiting information) specified by the provider (author) of the image data in the GOP 60 or the user who recorded the information and information indicating the playback mode of the image data such as the aspect ratio of the screen display.

The user information 64 includes information provided by the provider (author) of the image data in the GOP or the user who recorded the information, like the extension information. For example, it includes text data such as closed captions.

The user information 64 also contains special playback control information 70 for controlling special playback of the image data stored in the GOP 60, such as playback with thumbnails, partial playback, or fast-forward playback.

For example, special playback information 70 for controlling playback with a thumbnail presenting sequential still image playback has a playback format shown in FIG. 4. In particular, the special playback control information includes a user information start code, a special playback identification code (identification data of the present invention), a playback mode, playback interval data indicating the time interval from the playback of the current image data to the playback of the next image data during still image playback, the still image count indicating the number of still images during special playback, information about positions of a plurality of I pictures in special playback (hereinafter referred to as I picture position information (control information indicating playback order and recording position information of the present invention)), and their marker bits.

In the present invention, the user information start code has a fixed value, “000001B2,” and a first special playback identification code, TP (Trick Play), a second special playback code, MV (Movie), and a special playback mode, ST (Still image playback), are specified as fixed values, as shown in FIG. 4.

The start code “000001B2” is a value specified in MPEG Video specifications.

The I picture position information indicates the absolute position of image data in the GOP used in still image playback. During the special playback, I pictures are obtained on the basis of this position information.

Information about the position of an I picture is 48-bit data expressing the number of bytes counted from the beginning of a program stream 90 generated by reproducing data recorded on the DVD described above to the position of that I picture. The information is divided into three parts, upper (H), middle (M), and lower (L) order 16-bit parts, which are recorded separately.

A marker bit having a fixed value “1” is provided for each piece of I picture position information so as not to be regarded as the start code of the next user information. A byte align indicating is provided at the end of the special playback information in order to organize user data into bytes.

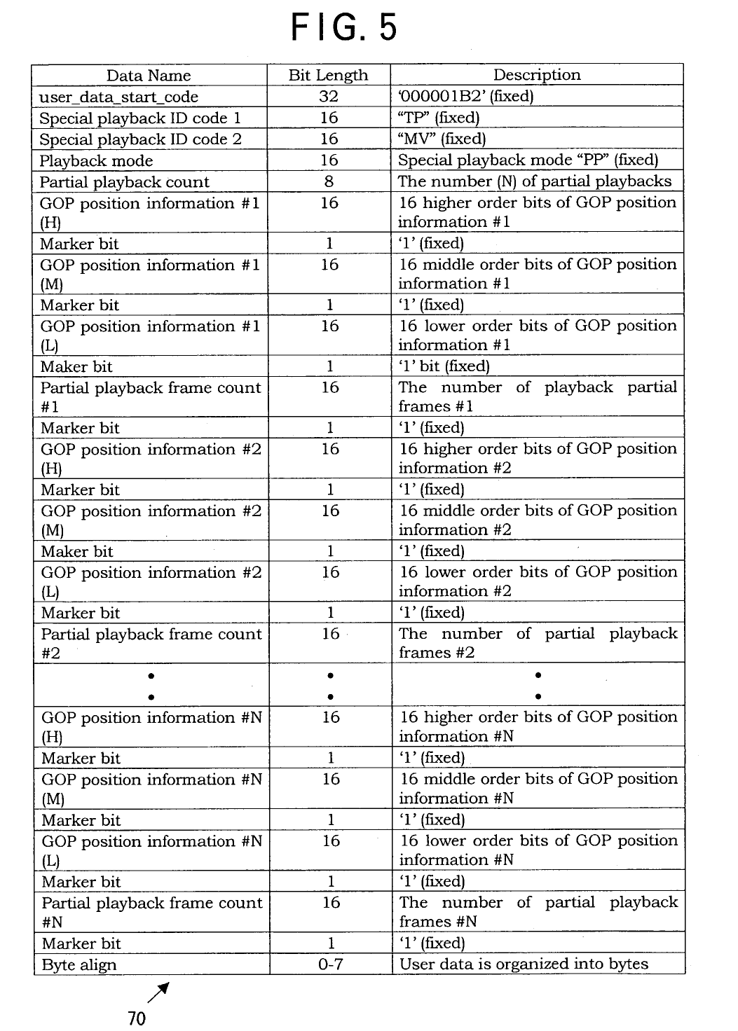

For partial playback, special playback information 70 has a playback format as shown in FIG. 5. In particular, it includes, like the example described above, a user information start code, a special playback identification code (identification data of the present invention), and a playback mode, as well as the partial playback count indicating the number of picture images to be played back during the partial playback, the partial playback frame count indicating the number of image frames played back (hereinafter referred to as GOP information (control information and recording position information of the present invention)) and their marker bits.

In the present embodiment, a first special playback identification code, TP (Trick Play) and a second special playback code, MV (Movie) are specified as fixed values like the example described above, and a playback mode, PP (Partial Play) is also specified as a fixed value.

The GOP position information indicates the absolute position of image data in the GOP used in partial playback. During the special playback, each pictures are obtained on the basis of this position information.

Each piece of GOP position information is 48-bit data expressing the number of bytes counted from the beginning of a program stream 90 generated by reproducing data recorded on the DVD described above to the position of that I picture. The information is divided into three parts, upper (H), middle (M), and lower (L) order 16-bit parts, which are recorded separately.

A marker bit having a fixed value “1” is provided for each piece of GOP position information so as not to be regarded as the start code of the next user information. A byte align indicating is provided at the end of the special playback information in order to organize user data into bytes.

The user information 64 is positioned at the beginning of each piece of frame image data (this positioning is hereinafter called localization). However, it may be dispersed between frame image data, for example, between an I picture and a B picture.

In the latter case, each piece of user information contains special playback information 70 for frame image data near that user information and the special playback control information 70 contains link information 71 (position information of the present invention) indicating the position of the

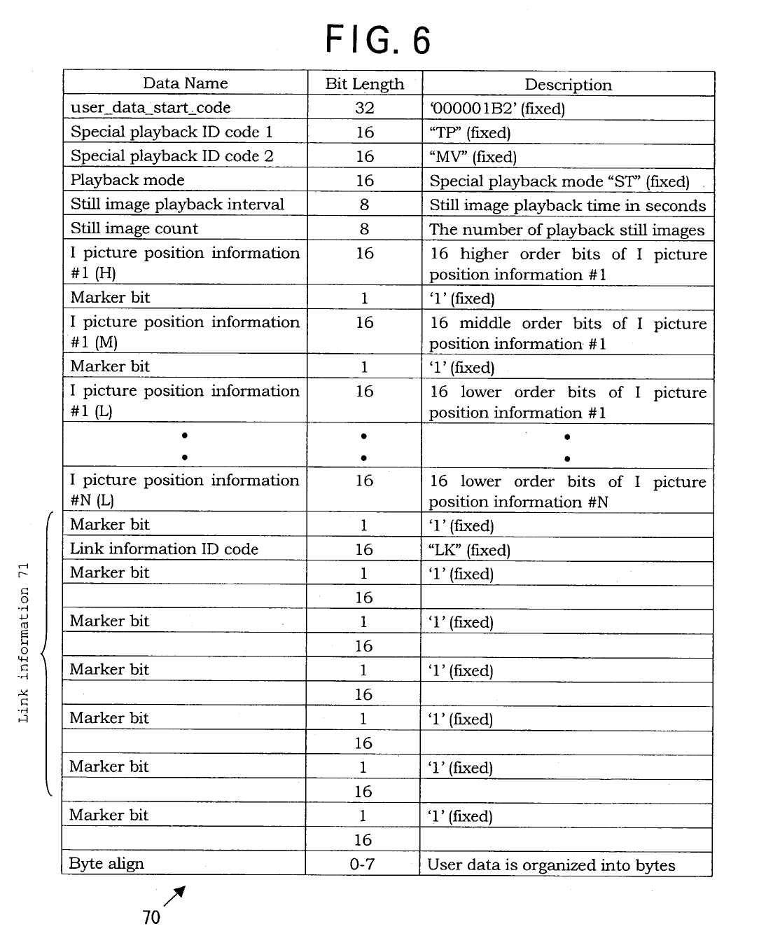

For example, when playback with thumbnails is controlled in which still images having the playback format as shown in FIG. 4 are played back one after another, the special playback information 70 contains a user information start code, a special playback identification code, a playback mode, still image playback interval data, still image count data, I picture position information, and its marker bit as well as a link information identification code for indicating whether or not link information exists, information indicating the position of preceding special playback control information 70 to which this control information 70 is linked (hereinafter referred to as the preceding link information) and information indicating the position of succeeding special playback control information 70 to which this control information 70 is linked (hereinafter called the succeeding link information), as shown in FIG. 6.

Like I picture information, each piece of GOP position information is 48-bit data expressing the number of bytes counted from the beginning of a program stream 90 generated by reproducing data recorded on the DVD described above to the position of that I picture. The information is divided into three parts, upper (H), middle (M), and lower (L) order 16-bit parts, which are recorded separately.

While the pack structure is described herein with respect to video packs 42, audio access units (AAUs) in audio packs 43 are equivalent to the GOPs described above.

A logical format (logical structure) which is a combination of items of information shown in FIG. 1 which are recorded in physically separated form will be described below with reference to FIG. 7.

The logical structure shown in FIG. 7 is not used for recording information on a DVD1. Rather, combining pieces of data such as cells 20 shown in FIG. 1 provides the logical structure shown in FIG. 7. Information such as access information or time information for playback is recorded on the DVD 1, in particular, in control data areas 11 and read out to construct the logical structure shown in FIG. 7.

As shown in FIG. 7, the physical structure described with respect to FIG. 1 is constructed by selecting and combining a number of cells 20 to construct a program 80 according to the intention of the author of the program 80.

The program 80 is the minimum logical unit that is distinguishable to and accessed by a system controller in the information player described earlier via a command. The single program 80 is logically constructed with a number of selected cells 20.

In the present video system, the minimum program unit is called a PTT (Part of Title). An author can define a program 80 as the minimum unit that can be selected by a viewer. The viewer can select to watch one such program or a collection of such programs.

Each cell 20 is assigned a number (hereinafter referred to as a cell ID number (indicated as “cell ID #” in FIG. 1) which is required in handling the cell in the physical format shown in FIG. 1. Playback is performed on the basis of cell IDs in the logical format.

In the present video system, the author of a content can use cell IDs to select discontinuous-cell playback mode in which cells are played back in a order different from that in which they are stored in a DVD 1 as well as contiguous-cell playback mode in which the cells 20 are played back in order.

One cell 20 can be reused; one cell 20 can be shared among a plurality of programs 80, that is, one cell 20 can be played back in different programs 80. Furthermore, cells 20 are played back in the order in which they are stored in the DVD 1 (contiguous-cell playback mode). In addition, the author can select cells to be played back without regard to the order in which they are recorded on the DVD 1 (discontiguous-cell playback mode).

The present video system has the logical structure described above. A plurality of programs 80 are combined to logically construct one PGC (Program Chain) 81 according to the intention of the author. The PGCI described earlier is defined by using the PGC 81 as a unit.

For example, PGCI include the playback order of cells in each program 80, playback mode of the program 80, the address of each cell, which indicates the position in which the cell is recorded, the number of start cell 20 to be reproduced in the program 80, and commands for the program that can be specified by the author for each PGC 81 or each cell 20. The PGCI is recorded in the control data 11 (see FIG. 1) on the DVD 1, as mentioned earlier.

PGCI concerning a menu in the video manager 2 is recorded in control data (not shown) within the video manager 2.

Each PGC 81 as a combination of programs 80, in other words, as a combination of cells 20, constitutes substantive data such as video and audio data, besides the PGCI.

In the present video system, on or more PGCs 81 make up one title 82 and one or more titles 82 make up one VTS 83 as shown in FIG. 7.

The title 82 is a unit equivalent to one movie, for example, and represents a complete piece of information the author wants to provide to a viewer of the DVD 1. The title 82 contained in the VTS 83 has attributes common to different versions of one movie, such as versions in different languages.

Information equivalent to one VTS 83 shown in FIG. 7 corresponds to information contained in one VTS 3 shown in FIG. 1. In particular, the entire information logically contained in the VTS 83 shown in FIG. 7 is recorded as one VTS 3 on a DVD 1.

On the basis of the logical format described above, the author specifies information sectionalized in the physical structure to construct a title (such as a movie) to present to a viewer.

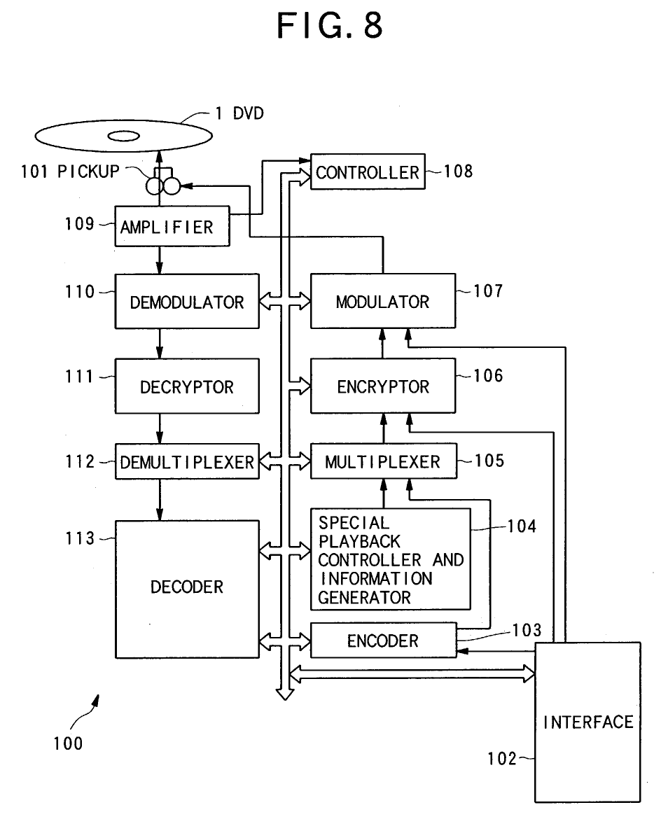

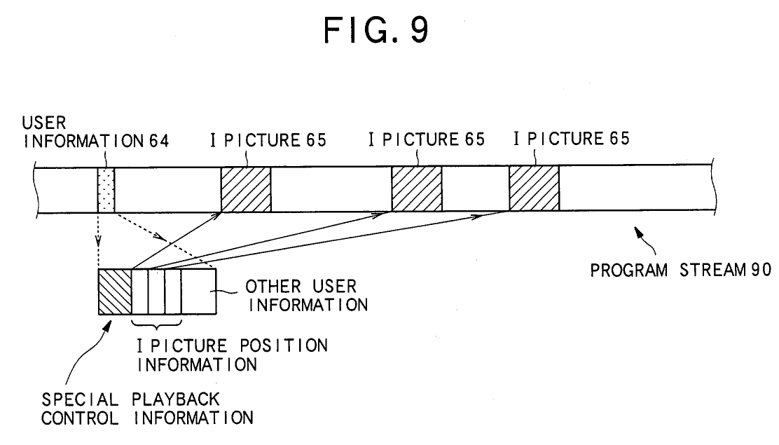

An information recorder/player for writing and reading content data on the DVD described above with reference to FIGS. 8 and 9 will be described below.

FIG. 8 is a block diagram showing a configuration of the information recorder/player. FIG. 9 shows relationship between special playback control information and I picture information.

The present embodiment will be described with respect to an example in which content data is written to and read from the DVD.

The information recorder/player 100 shown in FIG. 8 has a pickup 101 for driving a semiconductor laser according to content data inputted. A light beam is applied to the DVD 1 with the pickup 101 to read and write content data on the DVD 1.

The information recorder/player 100 comprises a interface 102 through which content data is inputted, a encoder 103 for encoding the inputted content data, a special playback control information generator 104 for generating special playback control information, a multiplexer 105 for including the special playback control information into the encoded content data, a encryptor 106 for applying predetermined encryption to the encoded content data for recording on a predetermined DVD 1, a modulator 107 for generating a modulated signal for controlling the pickup 101 on the basis of the encrypted content data, and a controller 108 for centrally controlling these components and generating control information for the content data to be recorded.

The recorder/player 100 also comprises an amplifier 109 for generating a playback signal from data obtained through the pickup 101, a demodulator 110 for applying predetermined demodulation to the playback signal to generate a demodulated signal, a decryptor 111 for decrypting and obtaining content data from the modulated signal, a demultiplexer 112 for obtaining special playback control information from the decrypted content data, and a decoder 113 for converting the content data into information in a predetermined format, namely, an audio signal and a video signal in a predetermined format.

The pickup 101 operates according to the modulated signal generated by the demodulator 107 when recording information to the DVD 1. On the basis of the modulated signal, a semiconductor laser (not shown) provided in the pickup 101 for applying a light beam to the DVD-R 1 is driven to emit the light beam the intensity of which changes according to information in the encrypted recording signal that is to be recorded.

The pickup 101 also emits a light beam having constant intensity for playback, receives the reflected light through a photodetector (not shown), and generates a detection signal that changes in accordance with changes in the intensity of the reflected light to output it to the amplifier 109.

Inputted into the interface 102 is content data in a predetermined format. The interface 102 provides the inputted content data to the encoder 103 and also provide information such as content management information and text data associated with the content data to the modulator 107.

Inputted into the encoder 103 is content data such as audio and video information. The encoder 103 applies MPEG-2 compression to the content data and outputs the compressed content data to the multiplexer 105 according to the format described above.

The encoder 103 has an audio encoder for encoding audio information included in content data and a video encoder for encoding video information included in the content data, for example.

The special playback control information generator 104 generates special playback information described above according to directions from the controller 107 and outputs the generated special playback control information to the multiplexer 105.

In particular, the special playback control information generator 104 generates information such as playback interval data, still image count data, and I picture position information shown in FIG. 4 on the basis of a control signal provided from the controller 107 and outputs and outputs the generated data to the multiplexer 105.

Inputted into the multiplexer 105 are compressed audio and video information, special playback control information, and control information generated by the controller. The multiplexer 105 generates the program stream 90 described above on the basis of the inputted video information, audio information, and control information and includes the special playback control information into the program stream 90.

In particular, the multiplexer 105 generates the program stream 90 on the basis of the video information, audio information, and control information, records the special playback control in the user information area of the program stream described earlier, and outputs the program stream 90 including the special play back control information to the encryptor 106.

Inputted into the encryptor 106 is program stream 90 including special playback control information. The encryptor 106 applies predetermined encryption, in particular, encryption conforming to SDMI (Secure Digital Music Initiative) specification, to the inputted program stream 90 to generate encrypted information and provides it to the modulator 107.

Inputted in the modulator 107 are information encrypted by the encryptor 106 and content management information. The modulator 107 controls the pickup 101 for recording the information on the DVD 1.

In particular, the modulator 107 generates a recording signal according to the encrypted information and content management information, generates according to the recording signal a control signal for controlling the pickup 101, and provides the control signal to the pickup 101.

The controller 108 comprises a central processing unit (hereinafter abbreviated to CPU) and memory and controls each components during recording and play back of the program stream 90.

An instruction from a user is inputted into the controller 108 through an operating unit, which is not shown. According to the inputted instruction or inputted content data, the controller 108 generates navi-packs, which are playback control information for controlling the playback mode of the content data, namely, the program stream 90, and controls the special playback control information generator 104 to cause it to generate special play back control information.

When the DVD 1 is played, the controller 108 obtains navi-packs to control the decoder to play back the program stream 90. It also controls the decoder 211 to perform special playback such as playback with thumbnails, partial playback, and fast-forward playback according to an instruction provided from the user through the operating unit (not shown).

In particular, when an instruction to perform special playback is provided from the user through the operating unit (not shown), the controller 108 obtains navi-packs or special playback control information through the demultiplexer 112 as will be described later and controls the decoder 211 according to the obtained navi-packs or special playback control information.

The amplifier 109 applies predetermined amplification and waveform shaping to a signal detected by the pickup 101 and generates a playback signal to output it to the demodulator 110.

The playback signal to which predetermined process is applied by the amplifier is inputted in to the demodulator 110. The demodulator 110 applies predetermined demodulation to the playback signal, generates encrypted information, which is an encrypted program stream 90, and content management information, provides the encrypted information to the decryptor 111 and provides content management information to the controller 108 or an external device for managing the program stream 90 to be played back.

Information such as text information mentioned above is generated by the demodulator 110 and outputted to a display unit, which is not shown.

Encrypted information generate by the modulator 110 is inputted into the decryptor 111. The decryptor 111 applies a predetermined process, in particular, decryption conforming to SDMI specification, to the encrypted information to decrypt the encrypted program stream 90 into a program stream 90 in the MPEG-2 format and outputs it to the demultiplexer 112.

The decrypted program stream 90 is inputted into the demultiplexer 112. The demultiplexer 112 obtains navi-packs or special playback control information from the inputted program stream 90 and outputs it to the controller 107.

Inputted into the decoder 113 are video information and audio information parts of the program stream 90, namely the video packs, audio packs, and sub-picture packs described earlier. The decoder 113 generates content data from these packs inputted under the control of the controller 107 and outputs it to an external device.

If the special playback control information is disposed in a localized position, the decoder 113, in response to an inputted instruction to perform special playback of a certain part of the content data, obtains user information from the program stream 90 as shown in FIG. 9, obtains I picture position information contained in the user information, obtains I pictures on the basis of the I picture position information, and outputs it to the external device to accomplish the special playback.

Therefore, the problem which would otherwise be caused by special playback control information localized in such a manner that a group contains only one piece of special playback control information or only one of a plurality of groups contains a piece of special playback control information can be avoided. That is, problems can be avoided such as a delay in accessing each data component in a large amount of special playback control information.

The receiver of the program stream can transfer the MPEG-2 compressed program stream including special playback control information without any loss of the special playback control information because the special playback control information is included in the video pack itself. The content data can be played back without adverse effect of the special playback control information contained in it.

Conventionally, a program stream resulting from MPEG-2 compression of content data consists of areas containing compressed content data such as video pack areas and audio pack areas, and navi-pack areas and, when the receiver of the content data transfers it, data contained in the navi-packs may not be properly transmitted, depending on arrangements of the receiver.

According to the present embodiment, therefore, special playback control information is included in content data itself so that the special playback control information can be properly sent even if data included in the navi-pack is not properly transmitted.

(Second Embodiment)

In a second embodiment, the present invention is applied to a data transmission apparatus that sends transport stream such as digital images transmitted through the Internet or digital broadcasting.

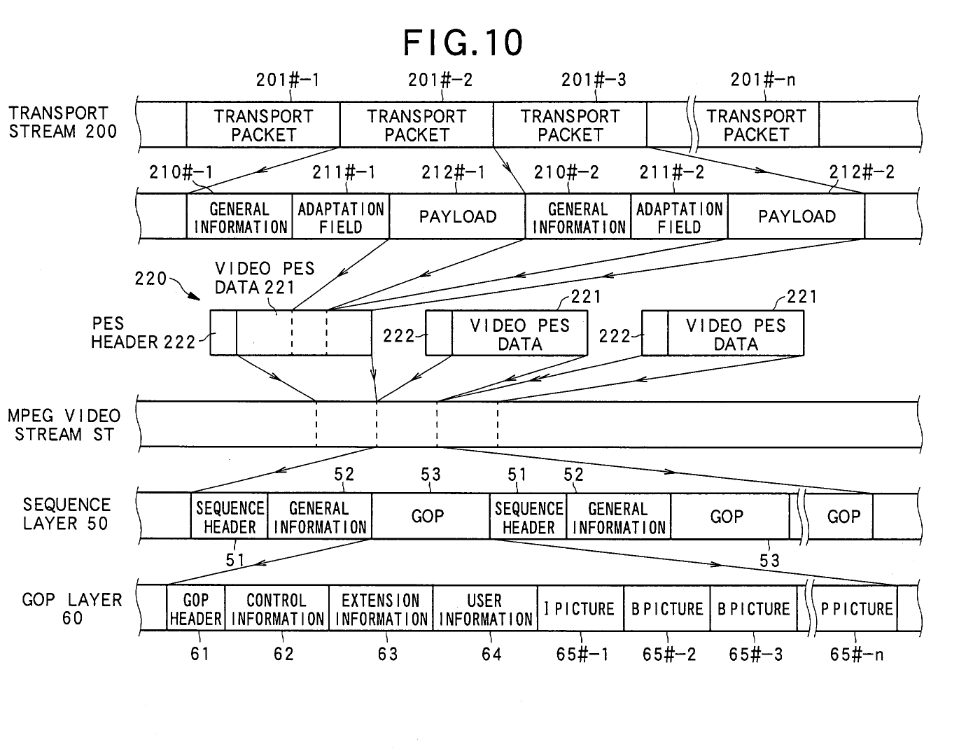

Referring to FIG. 10, a MPEG-2 transport stream will be described first.

FIG. 10 shows a data structure of a transport stream 200 in the MPEG-2 format.

As shown in FIG. 10, the MPEG-2 transport stream 200 such as digital images transmitted through the Internet or digital broadcasting consists of a number of transport packets 201 having a predetermined fixed length. A plurality of programs are multiplexed and demultiplexed by using the transport stream 200. A plurality of PES packets described above make up the transport packet 201.

One transport packet 201 consists of general information 210 field containing information such as the beginning of the transport packet 201, adaptation fields 211 for providing information about dynamic changes of status of the transport stream, and payloads 212, which are effective packed data.

The general information 210 includes indication of the start of each packet, information indicating whether the packet contains any error, information indicting the level of importance of the packet (transport packet 201 priority), identification information indicating the attribute of the stream (PID: Packet Identification), and adaptation field control information indicating whether or not the packet contains an adaptation fields 211 follows it and whether or the packet contains a payload 212.

The adaptation field 211 includes a discontinuous indicator for resetting a system clock, information indicating the start of frames of video data or audio data, whether the packet contained a payload 212 (stream priority), and an allowable range of multiplexed timing shifts.

A payload 212 is an effective packet data and forms a part of information such as video data or audio data. Therefore, video PES data 221 in a video PES 220, for example, can be built with payloads 212 and an MPEG video stream ST similar to that in the first embodiment can be built with the video PES data 221.

In particular, payload 212 data whose PIDs in general information 210 in a transport packet 201 are specified as video in the program map make up video PES data 221.

A video PES 220 consists of video PES data 221 having substantive video data and a PES header 222.

Like the one in the first embodiment, the MPEG video stream constructed includes a sequence layer 50 and a GOP layer 60. The same components of these layers are labeled with the same numbers as those in the first embodiment and the description of which will be omitted here.

The payload 212 contains a part of I picture information. Of course, payloads 212 in the other transport packets contain part of B picture information or user information containing special playback control information. The data in the transmitted the transport stream is transmitted as a whole.

The payload 212 contain control information, such as stream parameter information and link information as well as part of additional information (PSI: Program Specific Information) and, as with the first embodiment, part of audio data and sub-picture data, besides picture data and user information. These items of information, together with information contained in payloads 212 in the other transport packets 201, make up control information, additional, PSI information, audio data, and sub-picture data.

In the present embodiment, the transport stream 200 is decrypted and played back on the basis of the control information and additional information composed of a number of payloads 212.

In particular, a data receiving apparatus, which will be described later, selects one of multiplexed programs, obtains the PIDs of transport packets 201 in the selected individual stream, and obtains control information such as parameter information and link information and additional information in the stream to decrypt and played the program among the multiplexed programs in the transport stream 200.

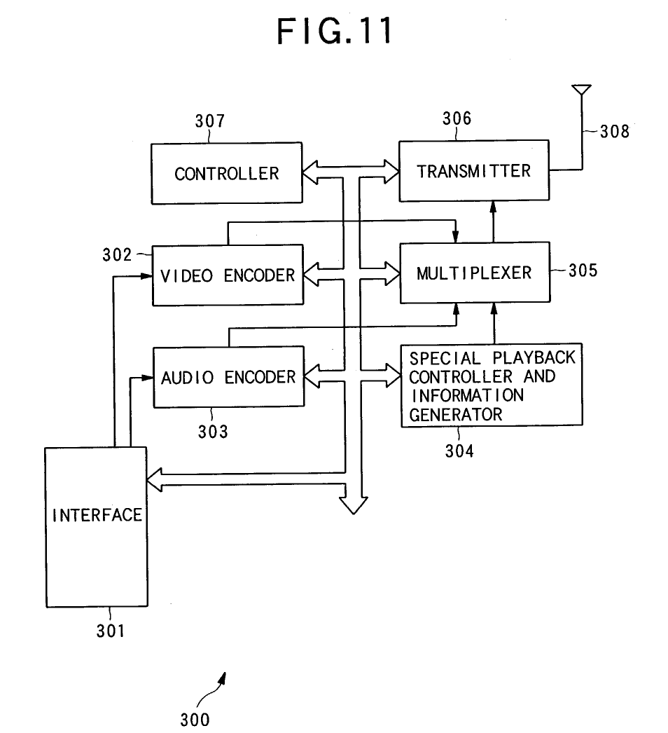

A data transmission apparatus for transmitting the transport stream described with respect to FIG. 11 will be described below.

FIG. 11 is a block diagram showing a configuration of a data transmission apparatus in the present embodiment.

The data transmission apparatus 300 in the present embodiment comprises an interface 301 through which content data is inputted, a video encoder 302 for compressing inputted video information into information the MPEG-2 format, an audio encoder 303 for encoding inputted audio information into information in the MPEG-2 format, a special playback control information generator 304 for generating control information controlling special playback according to special playback mode, a multiplexer 305 for including the special playback control information into a transport stream 200, a transmitter 306 for converting the transport stream 200 into a transmission signal in a predetermined format and transmitting it to a data receiving apparatus, which will be described later, through an antenna 308, and a controller 307 for controlling the components.

The video encoder 302 and audio encoder 303 constitute data compression means and the special playback control information generator 304 constitute generation means according to the present invention.

The multiplexer 305 constitutes the data compression means and data inclusion means according to the present invention and the transmitter 306 constitutes transmission means according to the present invention.

Inputted in the interface 301 is content data having a predetermined format from an external source. The interface 301 provides the inputted content data to the video encoder 302 and the audio encoder 303.

Video content data is inputted into the video encoder 302, which operates in coordination with the audio encoder 303. The video encoder 302 applies MPEG-2 compression to the content data and outputs compressed video information, namely video information transport packets 201 to the multiplexer 305.

Audio content data is inputted into the audio encoder 303, which operates in coordination with the video encoder 302. The audio encoder 303 applies MPEG-2 compression to the content data and outputs compressed audio information, namely audio information transport packets 201 to the multiplexer 305.

The special playback control information generator 304 generates special playback control information, like that described above, according to directions from the controller 307 and provides the generated special playback control information to the multiplexer 305.

For example, when special play back control information about special playback with thumbnails, the special playback control information generator 304 generates the playback interval data, still image count data, and I picture position information shown in FIG. 4 according to control signals provided from the controller 307 and outputs the generated data to the multiplexer 305.

The controller 307 coordinates the video encoder 302 brings the video encoder 302 and the audio encoder 303 into coordination on the basis of the data composition of the content data to be transmitted and controls compression of the video and audio information in the content data. It also controls the special playback control information generator 304 to generate special playback control information appropriate to the content data.

The controller 307 also generates PSI information concerning the content data to be transmitted and outputs the generated PSI information to the multiplexer 305.

Inputted in the multiplexer 305 are transport packets 201 of video and audio information compressed into the MPEG-2 format, special playback control information, and PSI information. The multiplexer 305 constructs a transport stream 200 on the basis of the inputted video and audio information transport packets 201 and PSI information, includes the special playback control information into the transport stream 200, and provides the transport stream 200 including the special playback control information to the transmitter 306.

The transport stream 200 including the special play back control information is inputted into the transmitter 306. The transmitter 306 converts the transport stream 200 into a transmission signal having a predetermined data format and transmits it to a data receiving apparatus through the antenna 308.

While the transport stream 200 is transmitted to the data receiving apparatus through the antenna in the present embodiment, it may be transmitted to the data receiving apparatus through cable communication over the Internet, for example.

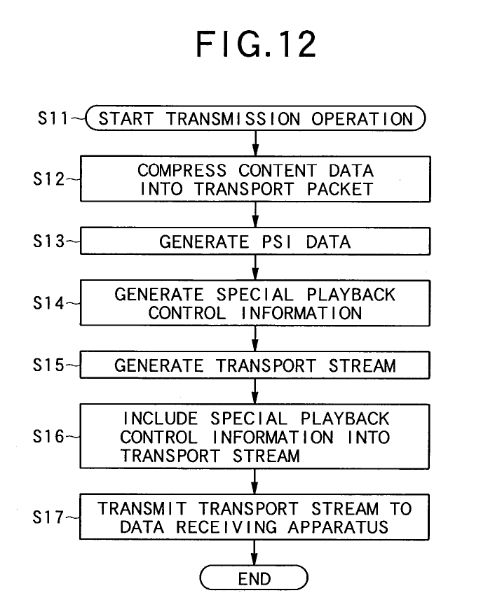

Operation for transmitting content data performed by the data transmission apparatus according to the present embodiment will be described below with reference to FIG. 12.

The assumption here is that the playback mode of special playback is set previously. FIG. 12 is a flowchart of the data transmission operation performed by the data transmission apparatus.

When a command for transmitting content data to the data receiving apparatus is entered in an operating unit (not shown) by an operator and the content data to transmit is provided to the interface 301 (step S11), the video encoder 302 and the audio encoder 303 compress the video information and audio information, respectively, in the content data into the MPEG-2 format, converts it into transport packets 201, and outputs it to the multiplexer 305 (step S12).

On the other hand, PSI information generated by the controller 307 is provided to the multiplexer 305 (step S13).

Then, special playback control information is generated by the special playback control information generator 304 on the basis of the special playback mode previously set and provided to the multiplexer 305 (step S14).

A transport stream 200 is generated by the multiplexer 305 on the basis of the inputted transport packets 201 and PSI information (step S15). The special playback control information is included into user information areas in the generated transport stream 200 and the transport stream 200 including the special playback control information is provided to the transmitter 306 (step S16).

In particular, the special playback control information includes special playback identification code for indicating whether or not special playback information is included and, besides this, includes playback mode, playback interval data, still image count data, and I picture position information for special play back with thumbnails, or playback order information, image frame position information, and playback time information for partial playback. These items of information are included in the transport stream 200.

If the pieces of special playback control information are located in a dispersed manner, link information indicating the position of the other pieces of special control information is also included in each piece of special playback control information in the transport stream 200.

The transport stream 200 is then converted by the transmitter 306 into a transmission signal having a predetermined data format and transmitted to the data receiving apparatus through the antenna 308 (step S17).

This operation process is terminated when an input (not shown) indicating the termination of the operation is provided or after the completion of the transmission of the transport stream.

In this way in the present embodiment, content data is converted into a transport stream and transmitted to the data receiving apparatus. The data transmission ends when a transmission abort instruction is provided through the operating unit (not shown) or after the data in the transport stream to be transmitted comes to the end.

Thus, the present embodiment allows the transport stream including special playback control information for controlling special playback intended by the author of the content data to be transmitted. Special playback of content data is performed on the basis of special playback control information for controlling special playback intended by the author of the content during special playback of the content data. Thus, various types of special playback intended by the content author, such as playback with thumbnails, partial playback, and fast-forward playback, can be ensured.

A receiving apparatus, which will be described below, that received the transport stream can transfer that MPEG-2 compressed transport stream including special playback control information without any loss of the special playback control information because the special playback control information is included in data (GOP) that carries frame image data. The content data can be played back without adverse effect of the special playback control information contained in it.

Conventionally, a transport stream resulting from MPEG-2 compression of content data consists of GOPs including compressed frame image data and GOPs having control information or PSI information such as additional information and, when the data receiving apparatus transfers the transport stream, data contained in the GOPs having PSI information may not be properly transmitted, depending on arrangements of the data receiving apparatus.

According to the present embodiment, therefore, special playback control information is included in the GOP containing frame image data so that the special playback control information can be properly sent even if PSI information is not properly transmitted.

(Third Embodiment)

In a third embodiment, the present invention is applied to a data receiving apparatus that receives transport streams such as digital images transmitted through the Internet or digital broadcasting.

In the third embodiment, the MPEG-2 transport stream provided in the second embodiment is received and the structure of the transport stream is the same as that described with respect to the second embodiment. Therefore the same components in the third embodiment as those in the second embodiment are labeled with the same reference numbers and the description of which will be omitted here.

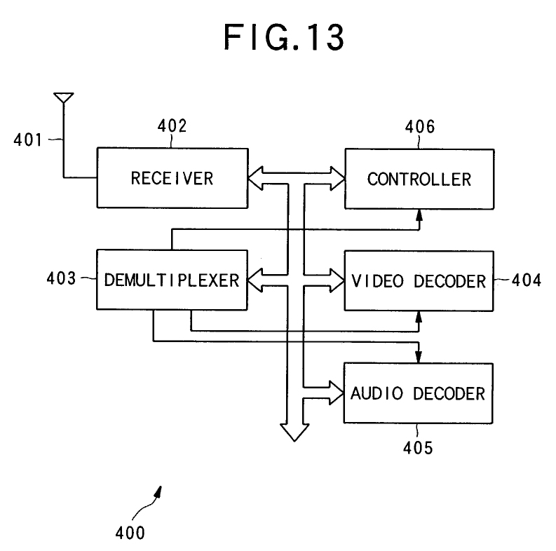

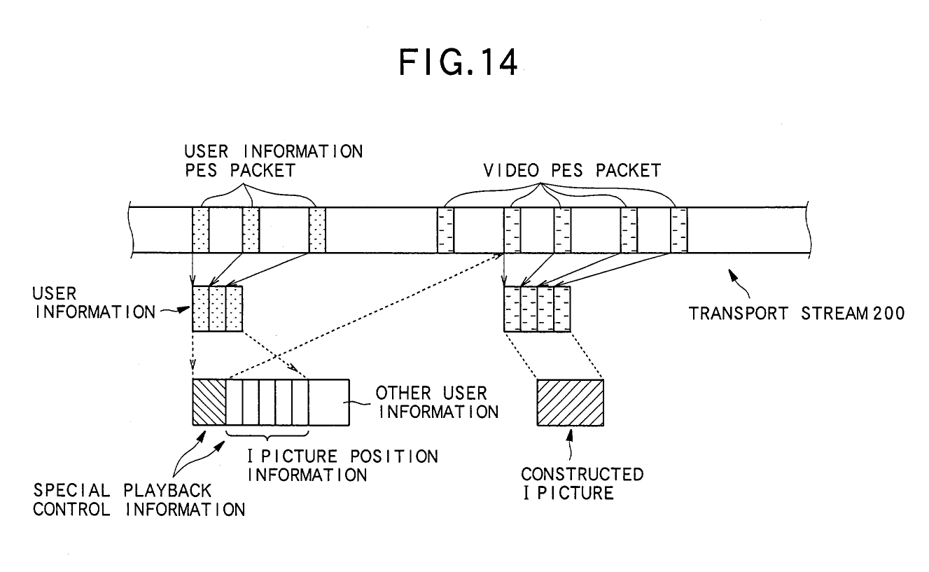

Referring to FIGS. 13 and 14, the data receiving apparatus that receives the transport stream described above will be described below.

FIG. 13 is a block diagram showing a configuration of the data receiving apparatus of the present embodiment. FIG. 14 shows an example of the relationship between the transport stream and user information during special playback according to special playback control information on a recording medium in the present embodiment.

The data receiving apparatus 400 of the present embodiment comprises a receiver 402 for receiving a transmission signal in a predetermined format through an antenna 401 and converting it into a transport stream 200, a demultiplexer 403 for extracting special playback control information from the received transport stream 200, a video decoder 404 and an audio decoder 405 for extracting video information and audio information from the transport stream 200 and reproducing the video information and audio information, and a controller 406 for controlling the video decoder 404 and the audio decoder 405.

The receiver 402 constitute receiving means according to the present invention and the demultiplexer 403 and the controller 406 constitute obtaining means and reproduction means according to the present invention.

A transmission signal in a predetermined format is inputted in the receiver 402 through the antenna 401. The receiver 402 converts the inputted transmission signal into a transport stream 200 and outputs it to the demultiplexer 403.

The transport stream 200 received at the receiver 402 is inputted into the demultiplexer 403. The demultiplexer 403 provides video information part of the inputted transport stream 200 to the video decoder 404 and provides audio information part to the audio decoder 405.

The demultiplexer 403 extracts PSI information, in particular special playback control information, included from the transport stream 200 and provides the extracted PSI information and special playback control information to the controller 406.

Inputted in the video decoder 404 is the video information part of the transport stream 200, namely transport packets 201 including payload 212 containing video information. The video decoder 404 decrypts the inputted transport packets 201 under the control of the controller 406 to generate video information and outputs it to a display unit or another external device.

For example, when performing special playback with thumbnails, the video decoder 404 obtains appropriate I picture data from the payloads 212 according to directions from the controller 406, constructs the special playback, and outputs it to the external device.

Likewise, inputted in the audio decoder 405 is the audio par of the transport stream 200, namely transport packets 201 including payload 212 containing audio information. The audio decoder 405 decrypts the inputted transport packets 201 under the control of the controller 406 to generate audio information and outputs it to the display unit or another external device.

In particular, when the audio decoder 405 is directed by the controller 406 to perform special playback, the audio decoder 405 obtains audio information corresponding to I pictures indicated by the controller 406 from the payloads 212, construct the audio information, and outputs it to the external device.

Inputted in the controller 406 are PSI information and special playback control information. The controller 406 controls the video decoder 404 and the audio decoder 405 according to an operation performed on a operating unit (not shown) and the inputted PSI information and special playback control information to perform normal playback or special playback of the video and audio information.

For example, when performing special playback control, the controller 406 obtains I picture position information from the obtained special playback control information as shown in FIG. 14 and controls the video decoder 404 on the basis of the I picture information and controls the audio decoder 405 to output audio information associated with the I pictures.

In particular, as with the first embodiment, video PES in the present embodiment is composed of a plurality of transport packets. Therefore, the controller 406 obtains I picture image frame data from the transport packets on the basis of the I picture position information, construct the I picture, and outputs it to the external device.

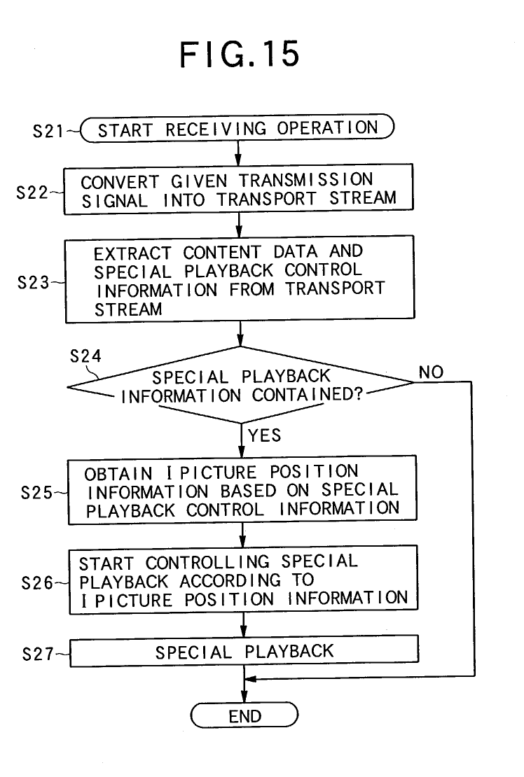

Operation performed by the data receiving apparatus for receiving transport stream data and providing special playback according to the present embodiment will be described below with reference to FIG. 15.

The operation will be described with respect to special playback with thumbnails.

FIG. 15 shows a flowchart of the special playback according to the present embodiment.

First, a direction is entered by an operator through an operating unit (not shown) that special playback (special playback with thumbnails) of content data is to be performed and a transmission signal in a predetermined format is started (step S21). Then, the receiver 402 converts the inputted transmission signal into a transport stream 200, which is outputted to the demultiplexer 403 (step S22).

The video information part and audio information part of the inputted transport stream are provided by the demultiplexer 403 to the video decoder and the audio decoder 405, respectively, and PSI information and special playback control information are provided to the controller 406 (step S23).

Then, it is determined by the controller 406 on the basis of an identification code whether the special playback control information for the special playback with thumbnails is contained (step S24).

If it is determined that the special playback control information is not contained, the operation ends.

On the other hand, if it is determined that the special control information is contained, I picture position information is obtained by the controller 406 on the basis of that special playback control information (step S25) and the video decoder 404 and the audio decoder 405 are controlled on the basis of the I picture position information (step S26) to perform the special playback.

In particular, the video decoder 404 obtains I picture data on the basis of the I picture position information and provides it to a display device or other external devices. The audio decoder 405 provides sound associated with the I picture to an external device.

The operation ends when an operation end command is inputted or the frame image data to be play backed comes to the end.

In this way, the transport stream is received, the contend data extracted from the transport stream and the special playback control information and other control information is also extracted to plays the content data back and accomplish the special playback according to the present embodiment. The data receiving operation ends when a command to stop the playback of the transport stream is entered through the operating unit, which is not shown, or after the reception of the transport stream to be received is completed.

The special playback operation has been described with respect to the special playback with thumbnails in the present embodiment. When partial playback is performed, it is determined at step S25 on the basis of an identification code whether special playback control information concerning the partial playback is contained and information about the image frames and playback time of image frames to be partially played back is obtained at step S25. Then, the special playback is performed on the basis of the information at step S26.

According to the present invention, special playback of content data is performed on the basis of special playback control information for controlling special playback intended by the author of the content during special playback of the content data. Thus, various types of special playback intended by the content author, such as playback with thumbnails, partial playback, and fast-forward playback, can be ensured.

Furthermore, the receiving apparatus that received the transport stream can transfer that MPEG-2 compressed transport stream including special playback control information without any loss of the special playback control information because the special playback control information is included in data (GOP) that carries frame image data. The content data can be played back without adverse effect of the special playback control information contained in it.

Conventionally, a transport stream resulting from MPEG-2 compression of content data consists of GOPs including compressed frame image data and GOPs having control information or PSI information such as additional information and, when the data receiving apparatus transfers the transport stream, data contained in the GOPs having PSI information may not be properly transmitted, depending on arrangements of the data receiving apparatus.

According to the present embodiment, therefore, special playback control information is included in the GOP containing frame image data so that the special playback control information can be properly sent even if PSI information is not properly transmitted.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-140698 filed on May 15, 2002 including the specification, claims, drawings and summary is incorporated herein by reference in its entirety.

What is claimed is:

1. A data transmission apparatus comprising:
a data compression device for compressing input content data into a data format consisting of a plurality of groups together with playback control information for controlling the playback of the content data, the groups being related to each other, each of the groups being a collection of a plurality of data components making up the content data;
a generation device for generating special playback control information for controlling special playback intended by a content author of the content data;
a data inclusion device for including the generated special playback control information into the compressed content data; and
a transmission device for transmitting the compressed data including the special playback control information.

2. The data transmission apparatus according to claim 1, wherein:
the data inclusion device includes into the compressed content data identification data indicating that the playback control information is contained in the content data when including the playback control information into the compressed content data.

3. The data transmission apparatus according to claim 1, wherein:
the special playback control information generated by the generation device includes at least either recording position information indicating the positions in which the data components used in the special playback are recorded or control information for controlling the order in which the data components are played back during the special playback or the length of time for which the special playback of each of the data components is performed.

4. The data transmission apparatus according to claim 1, wherein:
the generation device generates one or more pieces of special playback control information for controlling special playback of the data components of each of the groups in the content data and adds position information to each piece of the special playback control information for indicating the positions in which the other pieces of special playback control information are placed;
the inclusion device includes the one or more pieces of special playback control information generated into the each group.

5. A data receiving apparatus for receiving and playing back content data transmitted from the data transmission apparatus according to claim 1, the receiving apparatus comprising:
a receiving device for receiving the content data including special playback control information for controlling special playback intended by a content author, the content data being compressed into a data format consisting of a plurality of groups together with the playback control information for controlling the playback of the content data;
a obtaining device for obtaining the special playback control information included in the compressed content data; and
a playback device for decrypting the received compressed content data on the basis of the obtained special playback control information and performing the special playback of the content data.

6. The data receiving apparatus according to claim 5, wherein,
the content data contains identification information indicating that the content data contains the special playback control information and the obtaining device obtains the identification information when obtaining the special playback control information.

7. The data receiving apparatus according to claim 5, wherein:
the special playback control information includes at least either recording position information indicating the positions in which the data components used in the special playback are recorded or control information for controlling the order in which the data components are played back during the special playback or the length of time for which the special playback of each of the data components is performed;
the obtaining device obtains the control information when obtaining the special playback control information; and
the playback control device performs the special playback on the basis of the obtained control information.

8. The data receiving apparatus according to claim 5, wherein:
each of the groups includes one or more pieces of the special playback control information for controlling the special playback of the data components of each of the groups in the content data and position information indicating the positions in which the other pieces of special playback control information is added to each piece of the special playback control information; and
the playback device refers to each piece of the special playback control information included in each of the groups on the basis of each piece of the position information to perform the special playback.

9. A recording medium comprising:
a recording area for recording content data compressed together with playback control information for controlling the content data into a data format consisting of a plurality of groups, each of the groups being a collection of a plurality of related data components making up the content data, wherein
the recording area stores the compressed data including special playback control information for controlling special playback intended by the author of said content data.

10. The recording medium according to claim 9, wherein the recording area stores the content data including identification data indicating that the special playback control information is contained in the content data.

11. The recording medium according to claim 9, wherein the recording area stores the content data including special playback control information including control information for controlling at least either the order in which the data contents are played back during special playback or the length of time for which each of the data components is played back.

12. The recording medium according to claim 9, wherein:
each of the groups includes one or more pieces of the special playback control information for controlling special playback of the data components of each of the groups in the content data; and
the recording area stores the content data including the special playback control information, each piece of the special playback control information having position information indicating the positions in which the other pieces of special playback control information are placed.

13. A data transmission method comprising:
a data compression process of compressing input content data into a data format consisting of a plurality of groups together with playback control information controlling playback of the content data, each of the groups being a collection of plurality of data components making up the content data;
a generation process of generating special playback control information for controlling playback intended by the author of the content data;
a data inclusion process of including the generated special playback control information into the compressed content data; and
a transmission process of transmitting the compressed content data including the special playback control information.

14. The data transmission method according to claim 13, wherein:
the data inclusion process includes identification information into the content data for indicating that the content data contains the playback control information when the playback control information is included in the compressed content data.

15. The data transmission method according to claim 13, wherein:
the special playback control information includes at least either recording position information indicating the positions in which the data components used in the special playback are recorded or control information for controlling the order in which the data components are played back during the special playback or the length of time for which the special playback of each of the data components is performed.

16. The data transmission method according to claims 13, wherein:
the generation process generates one or more pieces of special playback control information for controlling special playback of the data components of each of the groups in the content data and adds position information to each piece of the special playback control information for indicating the positions in which the other pieces of special playback control information are placed.

17. A data receiving method for receiving and playing back content data transmitted by the transmission method according to claim 13, the data receiving method comprising:
a receiving process of receiving the content data compressed in a format consisting of a plurality of groups together with the playback control information for controlling the content data, the content data including special playback control information for controlling special playback intended by a content author;
an obtaining process of obtaining the special playback control information included in the compressed content data; and
a playback process of decrypting the received compressed data and performing the special playback of the content data on the basis of the obtained special playback control information.

18. The data receiving method according to claim 17, wherein:
the content data includes identification data indicating that the playback control information is contained in the content data; and
the obtaining process obtains the identification data when obtaining the special playback control information.

19. The data receiving method according to claim 17, wherein:
the special playback control information includes at least either recording position information indicating the positions in which the data components used in the special playback are recorded or control information for controlling the order in which the data components are played back during the special playback or the length of time for which the special playback of each of the data components is performed;
the obtaining process obtains the control information when obtaining the special playback control information; and
the playback control process performs the special playback on the basis of the obtained control information.

20. The data receiving method according to claim 17, wherein:
each of the groups includes one or more pieces of the special playback control information for controlling the special playback of the data components of each of the groups in the content data, and position information indicating the positions in which the other pieces of special playback control information is added to each piece of the special playback control information; and
the playback process refers to each piece of the special playback control information included in each of the groups on the basis of each piece of the position information to perform the special playback.
